(19) United States
(12) Patent Application Publication
(10) Pub. No.: US 2013/0300600 A1
(43) Pub. Date: Nov. 14, 2013

(54) PSEUDO-SATELLITE AND METHOD FOR TRANSMITTING MAGNITUDE-CONTROLLED NAVIGATION SIGNAL IN GLOBAL NAVIGATION SATELLITE SYSTEM

(71) Applicant: ELECTRONICS AND TELECOMMUNICATIONS RESEARCH INSTITUTE, Daejeon-city (KR)

(72) Inventor: Man-Ho PARK, Daejeon (KR)

(73) Assignee: Electronics and Telecommunications Research Institute, Daejeon-city (KR)

(21) Appl. No.: 13/891,654

(22) Filed: May 10, 2013

(30) Foreign Application Priority Data
May 14, 2012 (KR) 10-2012-0050886

(51) Int. Cl. G01S 19/11

(52) U.S. Cl. CPC G01S 19/11
USPC 342/357.48

(57) ABSTRACT

A pseudo-satellite for transmitting a magnitude-controlled navigation signal in a GNSS includes: an interface unit configured to receive a unique identifier of a pseudo-satellite; a signal transmission unit configured to transmit a navigation signal for location positioning in the GNSS; and a control unit configured to control the magnitude of the navigation signal transmitted by the signal transmission unit, using an envelope having a period which is determined according to the unique identifier of the pseudo-satellite, received through the interface unit.

### CROSS-REFERENCE(S) TO RELATED APPLICATIONS

This application claims priority to Korean Patent Application No. 10-2012-0050886, filed on May 14, 2012, which is incorporated herein by reference in its entirety.

### BACKGROUND OF THE INVENTION

1. Field of the Invention

Exemplary embodiments of the present invention relate to a pseudo-satellite and method for transmitting a magnitude-controlled navigation signal in a global navigation satellite system (GNSS); and, particularly, to a pseudo-satellite and method for transmitting a magnitude-controlled navigation signal in a GNSS, which is capable of increasing the reliability of a pseudo-satellite system by solving a near/far problem in a GNSS environment in which a user receives a navigation signal from a pseudo-satellite through a GNSS receiver.

2. Description of Related Art

Research on the GNSS began after the United States Department of Defense partially opened signals of a global positioning system (GPS), which is a representative GNSS, to the private sector. Currently, the GNSS has reached commercialization beyond research and development. Examples of location information providing systems using the GPS may include a car navigation system and a navigation system of an airplane or ship. Using only a GNSS receiver including the GPS, a user may relatively accurately recognize his/her position anywhere on the earth, which is a great advantage of the GNSS. However, the GNSS cannot be used in an area or indoor spaces where a navigation signal from a GNSS satellite is blocked, which is one of the few disadvantages of the GNSS.

In order to overcome such a disadvantage of the GNSS, a pseudo-navigation system using a pseudo-satellite system has been recently developed as a subsidiary system and application system of the GNSS. In the pseudo-navigation system using a pseudo-satellite system, a pseudo-satellite serving as a transmitter capable of transmitting the same navigation signal as the GNSS satellite is fixed and installed at a specific position on the ground, and then used to perform a position determination process in the same manner as the method using the GNSS satellite. Accordingly, a user may use positional information through a GNSS receiver even in indoor spaces.

The GNSS satellite is operated at an altitude of about 20,000 km from the ground. Therefore, although the position of a user on the ground is changed, the magnitudes of navigation signals received by the GNSS receiver are maintained almost constantly. In the case of the pseudo-satellite system, however, the pseudo-satellite is generally installed and operated at a height close to the ground. Therefore, although a user moves a short distance, the magnitudes of navigation signals of the pseudo-satellite, received by the GNSS receiver, may exhibit a large difference. FIG. 1 illustrates a pseudo-satellite system including a plurality of pseudo-satellites 10a to 10n and a plurality of GNSS receivers 20a to 20n of users. Referring to FIG. 1, when the GNSS receiver 20a is too close to the pseudo-satellite 10a, a navigation signal received from the corresponding pseudo-satellite 10a may be so strong as to disturb the reception of navigation signals from the other pseudo-satellites 10b to 10n or GNSS satellites (not illustrated). On the other hand, when the GNSS receiver 20a is too remote from the pseudo-satellite 10b, a navigation signal received from the corresponding pseudo-satellite 10b may be too weak. In this case, it is impossible to receive the navigation signal. Such a problem is referred to as a near/far problem.

In order to solve such a problem, a variety of conventional methods have been proposed. The conventional methods include a frequency offset method which applies an offset corresponding to a null frequency band of a GNSS signal to a navigation signal of a pseudo-satellite, a frequency hopping method which transmits a navigation signal of a pseudo-satellite in a null frequency band of a GNSS signal as a narrow-band signal, and a pulsing scheme method in which the transmission time of a navigation signal of a pseudo-satellite is restrictively operated.

Among the above-described methods, the pulsing scheme method transmits a navigation signal of the pseudo-satellite only during a part of the entire transmission time of a spread code such as a pseudo-random noise (PRN) code of the GPS, thereby minimizing signal interference with other satellites or GNSS satellites. Therefore, the hardware of the GNSS receiver does not need to be upgraded, unlike the other methods. However, when a plurality of pseudo-satellites are operated, the transmission start/end times and transmission time slots of the individual pseudo-satellites must be managed.

### SUMMARY OF THE INVENTION

An embodiment of the present invention is directed to a technology capable of solving a near/far problem by controlling the magnitude of a navigation signal transmitted from a pseudo-satellite in a navigation information system using a pseudo-satellite.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a pseudo-satellite for transmitting a magnitude-controlled navigation signal in a GNSS includes: an interface unit configured to receive a unique identifier of a pseudo-satellite; a signal transmission unit configured to transmit a navigation signal for location positioning in the GNSS; and a control unit configured to control the magnitude of the navigation signal transmitted by the signal transmission unit, using an envelope having a period T, which is determined according to the unique identifier of the pseudo-satellite, received through the interface unit.

The control unit may include a period determination section configured to determine the period Tᵢ as an inverse number of a prime number preset for a unique identifier of the pseudo-satellite.

The control unit may further include an envelope calculation section configured to calculate an envelope having the period Tᵢ determined by the period determination section.

The envelope may be calculated based on the following expression:

$${Env}_{i} ( t ) = 0.5 \times ( cos ( \frac{2 π}{{T}_{i}} \times t ) + 1 )$$

where Envᵢ(t) represents a function for the envelope, and t represents a time variable having a user-set signal repetition period as a maximum repetition period.

The control unit may further include a signal magnitude control section configured to control the magnitude of the navigation signal transmitted by the signal transmission unit based on the following expression: Signalᵢ(t)=GNSS_Waveformᵢ(t)×Envᵢ(t) where GNSS_Waveformᵢ(t) represents a navigation signal before the magnitude of the navigation signal is controlled by the signal magnitude control section, and Signalᵢ(t) represents the navigation signal of which the magnitude is controlled by the signal magnitude control section and which is transmitted by the signal transmission unit.

The pseudo-satellite may further include an identifier storage unit configured to store the unique identifier of the pseudo-satellite, received through the interface unit.

In accordance with another embodiment of the present invention, a method for transmitting a magnitude-controlled navigation signal in a GNSS includes: receiving a unique identifier of a pseudo-satellite; calculating an envelope having a period Tᵢ determined according to the unique identifier of the pseudo-satellite; and transmitting a navigation signal of which the magnitude is controlled according to the calculated envelope.

The period Tᵢ may be determined as an inverse number of a prime number preset for the unique identifier of the pseudo-satellite.

The envelope may be calculated based on the following expression:

$${Env}_{i} ( t ) = 0.5 \times ( cos ( \frac{2 π}{{T}_{i}} \times t ) + 1 )$$

where Envᵢ(t) represents a function for the envelope, and t represents a time variable having a user-set signal repetition period as a maximum repetition period.

The magnitude of the navigation signal may be controlled based on the following expression: Signalᵢ(t)=GNSS_Waveformᵢ(t)×Envᵢ(t) where GNSS_Waveformᵢ(t) represents a navigation signal before the magnitude of the navigation signal is controlled, and Signalᵢ(t) represents the navigation signal of which the magnitude is controlled.

### BRIEF DESCRIPTION OF THE DRAWINGS

FIG. 1 is a diagram for explaining a near/far problem which may occur in a pseudo-satellite system in which a plurality of pseudo-satellites and a plurality of GNSS receivers of users exist.

FIG. 2 is a diagram illustrating the configuration of a pseudo-satellite for transmitting a magnitude-controlled navigation signal in a GNSS in accordance with the embodiment of the present invention.

FIG. 3 is a diagram illustrating the configuration of a control unit in the pseudo-satellite illustrated in FIG. 2.

FIG. 4 illustrates envelopes calculated by an envelope calculation section of FIG. 3.

FIGS. 5 and 6 are flow charts for explaining a method for transmitting a magnitude-controlled navigation signal in a GNSS in accordance with the embodiment of the present invention.

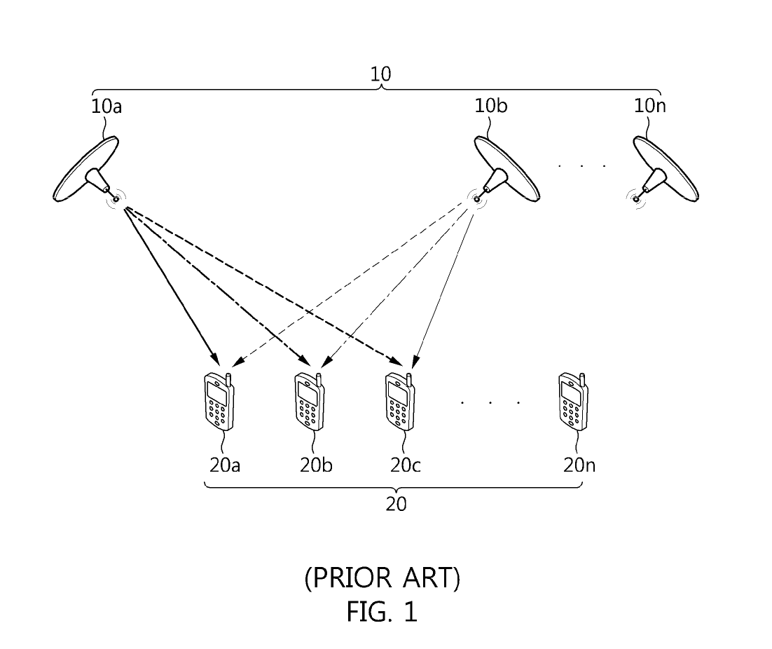

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

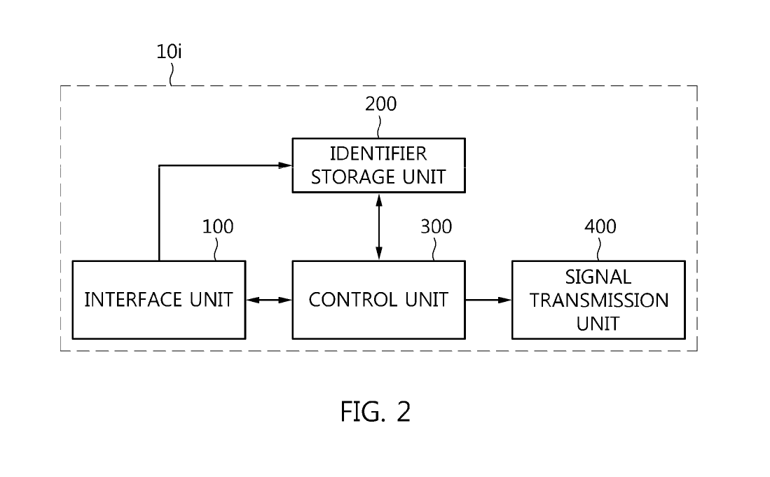

Hereafter, referring to FIGS. 2 to 4, the configuration and operation of a pseudo-satellite for transmitting a magnitude-controlled navigation signal in a GNSS in accordance with the embodiment of the present invention will be described.

FIG. 2 is a diagram illustrating the configuration of the pseudo-satellite for transmitting a magnitude-controlled navigation signal in a GNSS in accordance with the embodiment of the present invention.

Referring to FIG. 2, the pseudo-satellite 10i for transmitting a magnitude-controlled navigation signal in a GNSS in accordance with the embodiment of the present invention includes an interface unit 100, an identifier storage unit 200, a control unit 300, and a signal transmission unit 400. The interface unit 100 is configured to receive a control signal and a unique identifier of the pseudo-satellite 10i from a user. The identifier storage unit 200 is configured to store the unique identifier of the pseudo-satellite 10i, received through the interface unit 100. The control unit 300 is configured to control the respective units of the pseudo-satellite 10i and control the magnitude of a navigation signal. The signal transmission unit 400 is configured to transmit the navigation signal, of which the magnitude is controlled by the control unit 300, to a GNSS receiver of a user. In the GNSS environment to which the present invention is applied, a plurality of pseudo-satellites each including the above-described components may exist, and the pseudo-satellite 10i indicates an i-th pseudo-satellite among the pseudo-satellites.

The interface unit 100 performs an interface function for exchanging control signals and information between the user and the pseudo-satellite 10i, in order to provide a control function of the pseudo-satellite 10i by the user. Through the interface unit 100, the user may check basic settings of the pseudo-satellite 10i, settings for function control of the control unit 300, and the overall operation states of the pseudo-satellite 10i. Furthermore, the interface unit 100 receives the unique identifier of the pseudo-satellite 10i from the user. At this time, the unique identifier of the pseudo-satellite 10i, received from the user, indicates a unique identifier which discriminates the corresponding pseudo-satellite 10i from the other pseudo-satellites in the pseudo-satellite system in which the plurality of pseudo-satellites exist. That is, different unique identifiers are allocated to the respective pseudo-satellites in the pseudo-satellite system to which the present invention is applied.

The identifier storage unit 200 is configured to store the unique identifier of the pseudo-satellite 10i, received through the interface unit 100. The unique identifier of the pseudo-satellite 10i, stored in the identifier storage unit 200, may be preset during a manufacturing process of the pseudo-satellite 10i and stored in the identifier storage unit 200 instead of being inputted from the user through the interface unit 100. The above-described setting and storing process of the unique identifier of the pseudo-satellite 10i are only an example, and the present invention is not limited thereto. That is, the setting and storing process of the unique identifier of the pseudo-satellite 10i may be modified, if necessary.

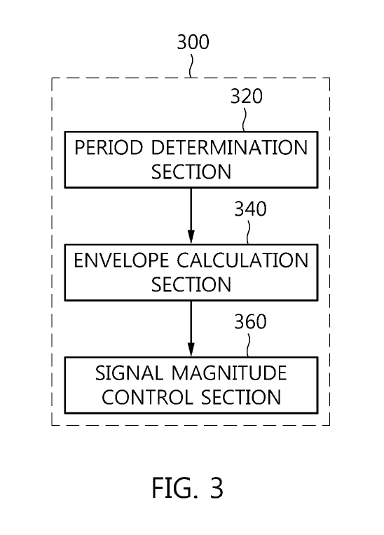

The control unit 300 serves to exchange control signals and information with the user through the interface unit 100 and control the overall functions of the pseudo-satellite 10i. That is, the control unit 300 processes parameters related to the navigation signal transmission of the pseudo-satellite 10i, and performs control functions of transmitting a navigation signal and checking a state by monitoring the transmitted navigation signal and the like. Furthermore, the control unit 300 controls the magnitude of the navigation signal transmitted to the GNSS receiver of the user through the signal transmission unit 400. The specific functions and operations of the control unit 300 to control the magnitude of the navigation signal transmitted through the signal transmission unit 400 will be described with reference to FIG. 3.

The signal transmission unit 400 is configured to transmit the navigation signal for location positioning to the GNSS receiver of the user according to the control of the control unit 300. The signal transmission unit 400 performs a function of generating and transmitting a navigation signal of the pseudo-satellite 10i, and is configured to transmit a navigation signal or user-set message using a preset spread code according to a user's settings. The baseband navigation signal processed using the preset spread code is modulated into a GNSS transmission band and then transmitted. At this time, the magnitude of the navigation signal transmitted by the signal transmission unit 400 is controlled by the control unit 300 according to the unique identifier stored in the identifier storage unit 200.

FIG. 3 is a diagram illustrating the configuration of the control unit 300 in the pseudo-satellite 10i illustrated in FIG. 2.

Referring to FIG. 3, the control unit 300 includes a period determination section 320, an envelope calculation section 340, and a signal magnitude control section 360.

The period determination section 320 is configured to determine the period T, of an envelope calculated by the envelope calculation section 340 as an inverse number of a prime number preset for the unique identifier of the pseudo-satellite 10i, stored in the identifier storage unit 200. The unique identifier of the pseudo-satellite 10i, stored in the identifier storage unit 200, has a different value from unique identifiers of other pseudo-satellites, and different prime numbers are previously allocated to the unique identifiers of the respective pseudo-satellites. The prime numbers previously allocated to the unique identifiers are used as scale values to determine the period of the envelope calculated by the envelope calculation section 340. At this time, the scale value scale(i) of the pseudo-satellite 10i is preset according to ‘scale(i)ε{2, 3, 5, 7, 11, 13, 17, 19, . . . , n}; n is a prime number’. The scale value of each of the pseudo-satellites is preset as a prime number different from the scale values of the other pseudo-satellites. The period determination section 320 determines the period Tᵢ of the envelope as an inverse number of the prime number preset for the unique identifier of the pseudo-satellite 10i, that is, ‘1/scale(i)’ corresponding to an inverse number of scale(i).

The envelope calculation section 340 is configured to calculate an envelope having a period determined by the period determination section 320. The envelope calculation section 340 calculates an envelope used when the signal magnitude control section 360 controls the magnitude of the navigation signal transmitted by the signal transmission unit 400. The envelope calculated by the envelope calculation section 340 has the period Tᵢ determined by the period determination section 320. At this time, the envelope Envᵢ(t) calculated by the envelope calculation section 340 may be determined by Equation 1 below, with respect to a time variable t having a user-set signal repetition period T as a maximum repetition period.

$${Env}_{i} ( t ) = 0.5 \times ( cos ( \frac{2 π}{{T}_{i}} \times t ) + 1 ) \qquad [ Equation 1 ]$$

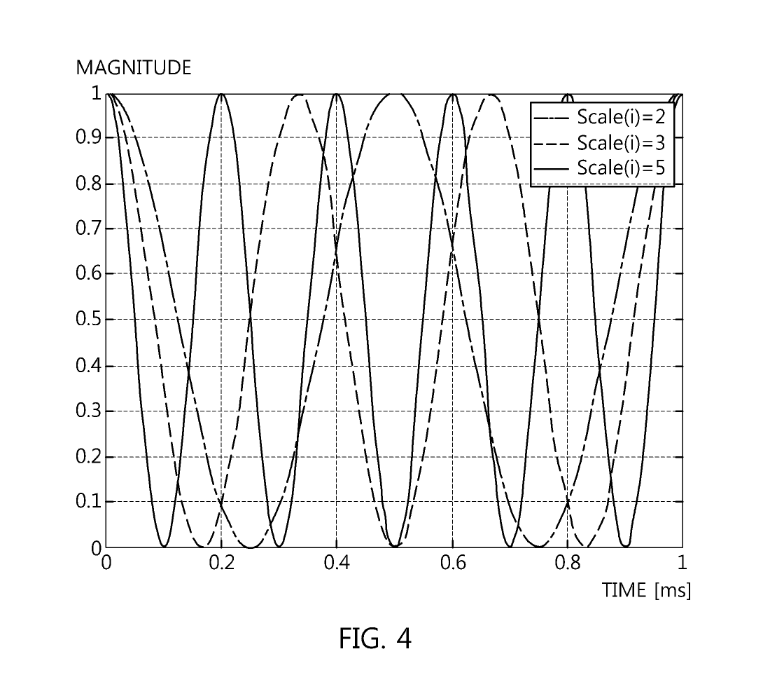

FIG. 4 illustrates envelopes calculated for the respective pseudo-satellites having unique identifiers, according to Equation 1.

The signal magnitude control section 360 controls the magnitude of the navigation signal transmitted from the signal transmission unit 400 using the envelope calculated by the envelope calculation section 340. That is, the signal magnitude control section 360 controls the magnitude of the navigation signal Signalᵢ(t) transmitted from the signal transmission unit 400 using the envelope Envᵢ(t) calculated by the envelope calculation section 340 according to Equation 2 below.

Signalᵢ(t)=GNSS_Waveformᵢ(t)×Envᵢ(t) [Equation 2]

Here, GNSS_Waveformᵢ(t) represents a navigation signal generated by the signal transmission unit 400, before the magnitude of the navigation signal is controlled by the signal magnitude control section 360.

As described above, the pseudo-satellite 10i to which the present invention is applied has a unique envelope as a navigation signal control parameter different from the other pseudo-satellites, according to the unique identifier thereof. The pseudo-satellite 10i controls the magnitude of the navigation signal transmitted from the signal transmission unit 400 using the unique envelope.

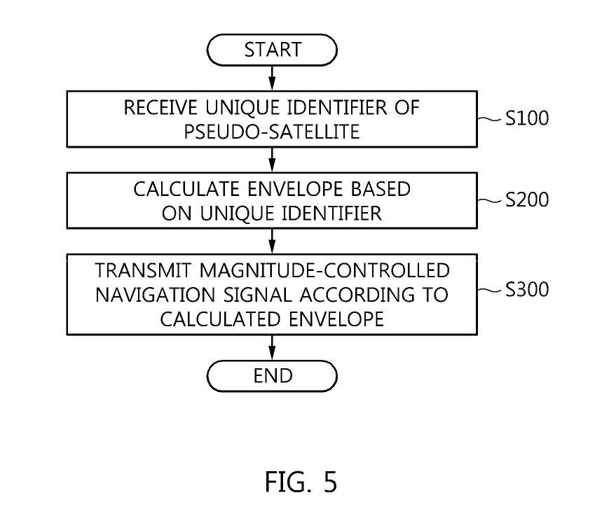

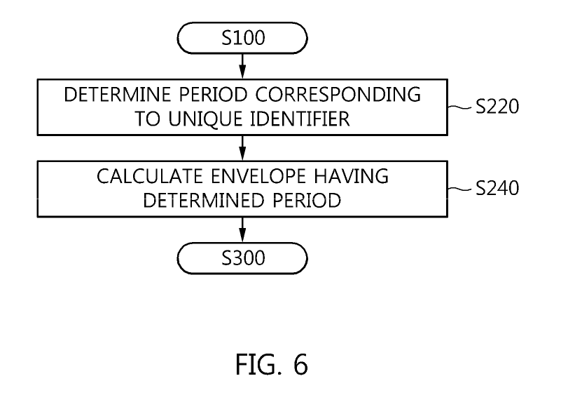

Hereafter, referring to FIGS. 5 and 6, a method for transmitting a magnitude-controlled navigation signal in a GNSS in accordance with the embodiment of the present invention will be described. In the following descriptions, duplications of the operation of the pseudo-satellite for transmitting a magnitude-controlled navigation signal in a GNSS in accordance with the embodiment of the present invention will be omitted.

FIG. 5 is a flow chart for explaining the method for transmitting a magnitude-controlled navigation signal in a GNSS in accordance with the embodiment of the present invention.

Referring to FIG. 5, the method for transmitting a magnitude-controlled navigation signal in a GNSS in accordance with the embodiment of the present invention is performed as follows. First, a unique identifier of the pseudo-satellite 10i is received from a user through the interface unit 100 at step S100. At this time, the unique identifier of the pseudo-satellite 10i, received from the user through the interface unit 100, is stored in the identifier storage unit 200. When the unique identifier of the pseudo-satellite 10i is preset during a manufacturing process of the pseudo-satellite 10i and stored in the identifier storage unit 200, step S100 may be omitted.

The control unit 300 calculates an envelope having a period Tᵢ based on the unique identifier of the pseudo-satellite 10i at step S200.

Then, the control unit 300 controls the magnitude of the navigation signal transmitted from the signal transmission unit 400 using the envelope calculated at step S200, and the signal transmission unit 400 transmits the navigation signal, of which the magnitude is controlled by the control unit 300, to a GNSS receiver of the user at step S300.

FIG. 6 is a flow chart for explaining step S200 in the method for transmitting a magnitude-controlled navigation signal in a GNSS in accordance with the embodiment of the present invention.

Referring to FIG. 6, step S200 in which the control unit 300 calculates the envelope having the period Tᵢ based on the unique identifier of the pseudo-satellite 10i is performed as follows. First, the period determination section 320 of the control unit 300 determines the period Tᵢ as an inverse number of a prime number preset for the unique identifier of the pseudo-satellite 10i, stored in the identifier storage unit 200, at step S220.

Then, the envelope calculation section 340 of the control unit 300 calculates an envelope Envᵢ(t) having the determined period Tᵢ based on the period T, determined by the period determination section 320 at step S220, according to Equation 1, at step S240. The envelope Envᵢ(t) calculated at step S240 is used when the signal magnitude control section 360 controls the magnitude of the navigation signal transmitted from the signal transmission unit 400 according to Equation 2 at step S300.

In accordance with the embodiment of the present invention, it is possible to provide an environment in which the magnitude of a navigation signal transmitted from a specific pseudo-satellite is higher than the magnitudes of navigation signals transmitted from other pseudo-satellites during 1/n time, in an environment in which a GNSS receiver of a user receives N navigation signals transmitted from N pseudo-satellites. Therefore, it is possible to guarantee that the GNSS receiver of the user receives the navigation signal transmitted from the specific pseudo-satellite. At other times, the magnitudes of the navigation signals transmitted from the other pseudo-satellites are set to be higher than the magnitude of the navigation signal transmitted from the specific pseudo-satellite. Therefore, the GNSS receiver of the user may be allowed to receive the navigation signals transmitted from GNSS satellites or the other pseudo-satellites. That is, regardless of whether the GNSS receiver of the user and the pseudo-satellite are close to each other or not, a ratio in which the GNSS receiver of the user receives the navigation signal transmitted from the specific pseudo-satellite and the navigation signals transmitted from the other pseudo-satellites may be controlled to increase the reliability of the GNSS using the pseudo-satellites.

While the present invention has been described with respect to the specific embodiments, it will be apparent to those skilled in the art that various changes and modifications may be made without departing from the spirit and scope of the invention as defined in the following claims.

What is claimed is:

1. A pseudo-satellite for transmitting a magnitude-controlled navigation signal in a global navigation satellite system (GNSS), comprising:
an interface unit configured to receive a unique identifier of a pseudo-satellite;
a signal transmission unit configured to transmit a navigation signal for location positioning in the GNSS; and
a control unit configured to control the magnitude of the navigation signal transmitted by the signal transmission unit, using an envelope having a period Tᵢ which is determined according to the unique identifier of the pseudo-satellite, received through the interface unit.

2. The pseudo-satellite of claim 1, wherein the control unit comprises a period determination section configured to determine the period Tᵢ as an inverse number of a prime number preset for a unique identifier of the pseudo-satellite.

3. The pseudo-satellite of claim 2, wherein the control unit further comprises an envelope calculation section configured to calculate an envelope having the period Tᵢ determined by the period determination section.

4. The pseudo-satellite of claim 3, wherein the envelope is calculated based on the following expression:
$${Env}_{i} ( t ) = 0.5 \times ( cos ( \frac{2 π}{{T}_{i}} \times t ) + 1 )$$
where Envᵢ(t) represents a function for the envelope, and t represents a time variable having a user-set signal repetition period as a maximum repetition period.

5. The pseudo-satellite of claim 4, wherein the control unit further comprises a signal magnitude control section configured to control the magnitude of the navigation signal transmitted by the signal transmission unit based on the following expression:
Signalᵢ(t)=GNSS_Waveformᵢ(t)×Envᵢ(t)
where GNSS_Waveformᵢ(t) represents a navigation signal before the magnitude of the navigation signal is controlled by the signal magnitude control section, and Signalᵢ(t) represents the navigation signal of which the magnitude is controlled by the signal magnitude control section and which is transmitted by the signal transmission unit.

6. The pseudo-satellite of claim 1, further comprising an identifier storage unit configured to store the unique identifier of the pseudo-satellite, received through the interface unit.

7. A method for transmitting a magnitude-controlled navigation signal in a GNSS, comprising:
receiving a unique identifier of a pseudo-satellite;
calculating an envelope having a period Tᵢ determined according to the unique identifier of the pseudo-satellite; and
transmitting a navigation signal of which the magnitude is controlled according to the calculated envelope.

8. The method of claim 7, wherein the period Tᵢ is determined as an inverse number of a prime number preset for the unique identifier of the pseudo-satellite.

9. The method of claim 8, wherein the envelope is calculated based on the following expression:
$${Env}_{i} ( t ) = 0.5 \times ( cos ( \frac{2 π}{{T}_{i}} \times t ) + 1 )$$
where Envᵢ(t) represents a function for the envelope, and t represents a time variable having a user-set signal repetition period as a maximum repetition period.

10. The method of claim 9, wherein the magnitude of the navigation signal is controlled based on the following expression:
Signalᵢ(t)=GNSS_Waveformᵢ(t)×Envᵢ(t)
where GNSS_Waveformᵢ(t) represents a navigation signal before the magnitude of the navigation signal is controlled, and Signalᵢ(t) represents the navigation signal of which the magnitude is controlled.
